(19) United States
(12) Patent Application Publication
(10) Pub. No.: US 2023/0236359 A1
(43) Pub. Date: Jul. 27, 2023

(54) METASURFACE OPTICAL DEVICE WITH ENERGY BANDGAP, AND OPTICAL APPARATUS

(71) Applicant: Shphotonics Ltd, Suzhou (CN)

(72) Inventors: Lei SUN, Suzhou (CN); Bing QIU, Suzhou (CN)

(21) Appl. No.: 18/157,343

(22) Filed: Jan. 20, 2023

(30) Foreign Application Priority Data
Jan. 21, 2022 (CN) 202220205197.2

(51) Int. Cl. G02B 6/122; G02B 1/00; B82Y 20/00

(52) U.S. Cl. CPC G02B 6/1225; G02B 1/005; B82Y 20/00; G02B 2006/1213

(57) ABSTRACT

A metasurface optical device includes a substrate and a nano-structure layer. The nano-structure layer is arranged on the substrate and includes a plurality of photonic crystal units. Each photonic crystal unit includes a plurality of nano-structure units arranged on the substrate such that an energy bandgap is formed in a cross-section of the photonic crystal unit parallel to the substrate. The energy bandgap surrounds the center area of the cross-section.

### CROSS-REFERENCE TO RELATED APPLICATION

This application claims priority to Chinese Application No. 202220205197.2, filed on Jan. 21, 2022, the entire content of which is incorporated herein by reference.

### TECHNICAL FIELD

The present disclosure relates to the metasurface technology field and, in particular, to a metasurface optical device and an optical apparatus.

### BACKGROUND

Metasurface refers to an artificial two-dimensional material with the sizes of basic structure units smaller than the working wavelengths and usually in the order of nanometers. Metasurface can realize flexible and effective control of the characteristics, such as polarization, amplitude, phase, propagation direction and mode, etc., of electromagnetic waves.

Metasurface can make ultra-light, ultra-thin, and multifunctional optical devices. Compared with conventional optical devices, a metasurface optical device manufactured based on semiconductor technology has the advantages of excellent optical performance, small size, and high integration. Metasurface optical devices can be widely used in future portable and miniaturized devices, such as augmented reality wearable devices, virtual reality wearable devices, and mobile terminal lenses.

### SUMMARY

Embodiments of the present disclosure provide a metasurface optical device, including a substrate and a nano-structure layer. The nano-structure layer is arranged on the substrate and includes a plurality of photonic crystal units. Each photonic crystal unit of the plurality of photonic crystal units includes a plurality of nano-structure units arranged on the substrate such that an energy bandgap is formed in a cross-section of the photonic crystal unit parallel to the substrate. The energy bandgap surrounds the center area of the cross-section.

Embodiments of the present disclosure provide an optical apparatus, including a metasurface optical device. The metasurface optical device includes a substrate and a nano-structure layer. The nano-structure layer is arranged on the substrate and includes a plurality of photonic crystal units. Each photonic crystal unit of the plurality of photonic crystal units includes a plurality of nano-structure units arranged on the substrate such that an energy bandgap is formed in a cross-section of the photonic crystal unit parallel to the substrate. The energy bandgap surrounds the center area of the cross-section.

### BRIEF DESCRIPTION OF THE DRAWINGS

FIG. 1 is a schematic structural diagram of a metasurface optical device.

FIG. 2 is a schematic diagram showing the operation principle of an example metasurface optical device.

FIG. 3 is a schematic structural diagram of a metasurface optical device according to some embodiments of the present disclosure.

FIGS. 4A-4E are top views schematically showing structures of photonic crystal units according to some embodiments of the present disclosure.

FIGS. 5A and 5B are side views schematically showing structures of photonic crystal units according to some embodiments of the present disclosure.

FIGS. 6A and 6B are schematic structural diagrams of metasurface optical devices according to some embodiments of the present disclosure.

FIG. 7 is a schematic structural diagram of an optical apparatus according to some embodiments of the present disclosure.

### DETAILED DESCRIPTION OF THE EMBODIMENTS

In the following, some example embodiments are described. As those skilled in the art would recognize, the described embodiments can be modified in various manners, all without departing from the spirit or scope of the present disclosure. Accordingly, the drawings and descriptions are illustrative in nature and not limiting.

In the present disclosure, terms such as “first,” “second,” and “third” can be used to describe various elements, components, regions, layers, and/or parts. However, these elements, components, regions, layers, and/or parts should not be limited by these terms. These terms are only used to distinguish one element, component, region, layer, or part from another element, component, region, layer, or layer. Therefore, a first element, component, region, layer, or part discussed below can also be referred to as a second element, component, region, layer, or part, which does not constitute a departure from the teachings of the present disclosure.

A term specifying a relative spatial relationship, such as “below,” “beneath,” “lower,” “under,” “above,” or “higher,” can be used in the disclosure to describe the relationship of one or more elements or features relative to other one or more elements or features as illustrated in the drawings. These relative spatial terms are intended to also encompass different orientations of the device in use or operation in addition to the orientation shown in the drawings. For example, if the device in a drawing is turned over, an element described as “beneath,” “below,” or “under” another element or feature would then be “above” the other element or feature. Therefore, an example term such as “beneath” or “under” can encompass both above and below. Further, a term such as “before,” “in front of,” “after,” or “subsequently” can similarly be used, for example, to indicate the order in which light passes through the elements. A device can be oriented otherwise (e.g., being rotated by 90 degrees or being at another orientation) while the relative spatial terms used herein still apply. In addition, when a layer is referred to as being “between” two layers, it can be the only layer between the two layers, or there can be one or more intervening layers.

Terminology used in the disclosure is for the purpose of describing the embodiments only and is not intended to limit the present disclosure. As used herein, the terms “a,” “an,” and “the” in the singular form are intended to also include the plural form, unless the context clearly indicates otherwise. Terms such as “comprising” and/or “including” specify the presence of stated features, entities, steps, operations, elements, and/or parts, but do not exclude the existence or addition of one or more other features, integers, steps, operations, elements, parts, and/or combinations thereof. As used herein, the term “and/or” includes any and all combinations of one or more of the listed items. The phrases “at least one of A and B” and “at least one of A or B” mean only A, only B, or both A and B.

When an element or layer is referred to as being “on,” “connected to,” “coupled to,” or “adjacent to” another element or layer, the element or layer can be directly on, directly connected to, directly coupled to, or directly adjacent to the other element or layer, or there can be one or more intervening elements or layers. In contrast, when an element or layer is referred to as being “directly on,” “directly connected to,” “directly coupled to,” or “directly adjacent to” another element or layer, then there is no intervening element or layer. “On” or “directly on” should not be interpreted as requiring that one layer completely covers the underlying layer.

In the disclosure, description is made with reference to schematic illustrations of example embodiments (and intermediate structures). As such, changes of the illustrated shapes, for example, as a result of manufacturing techniques and/or tolerances, can be expected. Thus, embodiments of the present disclosure should not be interpreted as being limited to the specific shapes of regions illustrated in the drawings, but are to include deviations in shapes that result, for example, from manufacturing. Therefore, the regions illustrated in the drawings are schematic and their shapes are not intended to illustrate the actual shapes of the regions of the device and are not intended to limit the scope of the present disclosure.

Unless otherwise defined, all terms (including technical and scientific terms) used herein have the same meaning as commonly understood by those of ordinary skill in the art to which this disclosure belongs. Terms such as those defined in commonly used dictionaries should be interpreted to have meanings consistent with their meanings in the relevant field and/or in the context of this disclosure, unless expressly defined otherwise herein.

As used herein, the term “substrate” can refer to the substrate of a diced wafer, or the substrate of an un-diced wafer. Similarly, the terms “chip” and “die” can be used interchangeably, unless such interchange would cause conflict. The term “layer” can include a thin film, and should not be interpreted to indicate a vertical or horizontal thickness, unless otherwise specified.

In the specification, phrases like “parameters B of a plurality of A's are not completely the same” mean that the plurality of A's are intentionally designed such that the parameters B of the plurality of A's formed by the manufacturing process are not all the same. Thus, these parameters B that are not all the same should not be interpreted as the result of errors in the manufacturing process, and vice versa. For example, “the dimensions of the plurality of nano-structure units in the direction perpendicular to the substrate are not completely the same” means that the plurality of nano-structure units are designed in a way that their vertical dimensions are not all the same, and the difference in the vertical dimensions is not due to manufacturing process errors or measurement errors.

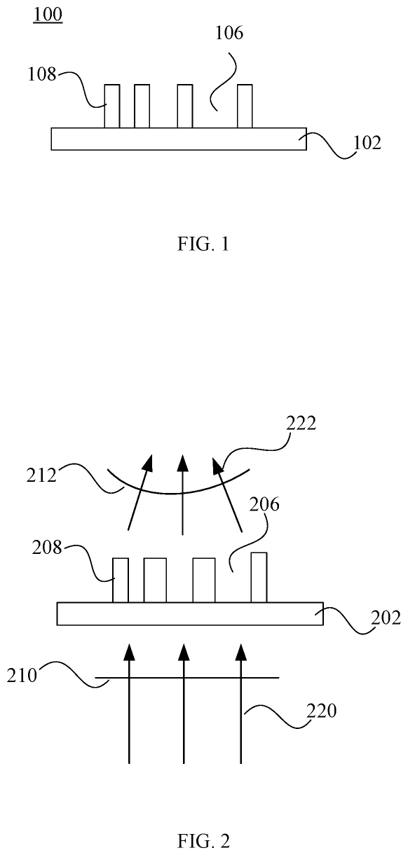

FIG. 1 is a schematic structural diagram of a metasurface optical device 100. As shown in FIG. 1, the metasurface optical device 100 includes a substrate 102, a plurality of nano-structure units (e.g., nanopillars) 108 arranged on the substrate 102, and protection medium material 106 protecting the plurality of nano-structure units 108. The plurality of nano-structure units 108 have a sub-wavelength size, and hence can realize local modulation of light at a corresponding working wavelength. When light passes through the metasurface optical device 100, an array of the plurality of nano-structure units 108 flexibly and effectively regulates characteristics of the light such as polarization, amplitude, phase, polarization mode, and propagation mode. Further, the plurality of nano-structure units 108 may have different sizes, shapes, and arrangement periods on the substrate 102. The protection medium material 106 is arranged to surround the plurality of nano-structure units 108 for protection and support. In the metasurface optical device 100, a refractive index of a material of the plurality of nano-structure units 108 is greater than a refractive index of the protection medium material 106, such that the light passing through the plurality of nano-structure units 108 mainly propagates therein.

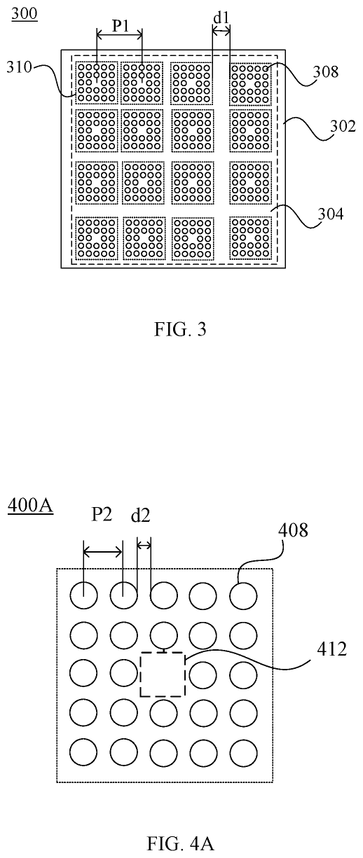

FIG. 2 is a schematic diagram showing operation principle of an exemplary metasurface optical device. As shown in FIG. 2, when an incident light 220 enters the metasurface optical device, a portion of the incident light 220 enters the plurality of nano-structure units 208 through the substrate 202, and another portion of the incident light 220 enters the protection medium material 206 through the substrate 202. Because the refractive index of the material of the plurality of nano-structure units 208 is greater than the refractive index of the protection medium material 206, the portion of the incident light 220 entering the plurality of nano-structure units 208 mainly propagates inside the plurality of nano-structure units 208. The portion of the incident light 220 not entering the plurality of nano-structure units 208 passes directly through the protection medium material 206. In this way, the metasurface optical device locally modulates the incident light 220 through the plurality of nano-structure units 208 having different effective refractive indices thereon, and changes optical characteristics of the incident light 220, such as the polarization, amplitude, phase, polarization mode, and propagation mode, etc. As shown in FIG. 2, the incident light 220 originally having a planar wavefront 210 becomes an outgoing light 222 having a curved wavefront 212 after passing through the metasurface optical device, thereby realizing modulation of the wavefront of light.

However, in related art, the refractive index of the material of the plurality of nano-structure units and the refractive index of the protection medium material need to meet certain requirements, that is, the refractive index of the material of the plurality of nano-structure units needs to be greater than the refractive index of the surrounding protection medium material, such that the portion of the light incident entering the plurality of nano-structure units mainly propagates therein. Thus, selection of the materials of the plurality of nano-structure units and the protection medium material in metasurface optical device is limited to a certain extent.

To solve the above problem, embodiments of the present disclosure provide a metasurface optical device and an optical apparatus including the metasurface optical device. The metasurface optical device can include photonic crystal units formed by a plurality of nano-structure units arranged according to a certain rule. The photonic crystal unit can form an energy bandgap in a cross-section of the photonic crystal unit parallel to a substrate. The energy bandgap can be configured to limit the light to mainly propagate in a center area of the cross-section of the photonic crystal units surrounded by the energy bandgap. The requirement that the refractive index of the material in the center area of the cross-section of the photonic crystal unit is greater than the refractive index of the surrounding protection medium material does not need to be satisfied.

In embodiments of the present disclosure, the metasurface optical device can include a substrate and a nano-structure layer on the substrate. The nano-structure layer can include a plurality of photonic crystal units. Each photonic crystal unit of the plurality of photonic crystal units can include a plurality of nano-structure units arranged on the substrate. The plurality of nano-structure units can be arranged to cause the photonic crystal unit to form the energy bandgap in the cross-section of the photonic crystal unit parallel to the substrate. The energy bandgap can surround the center area of the cross-section.

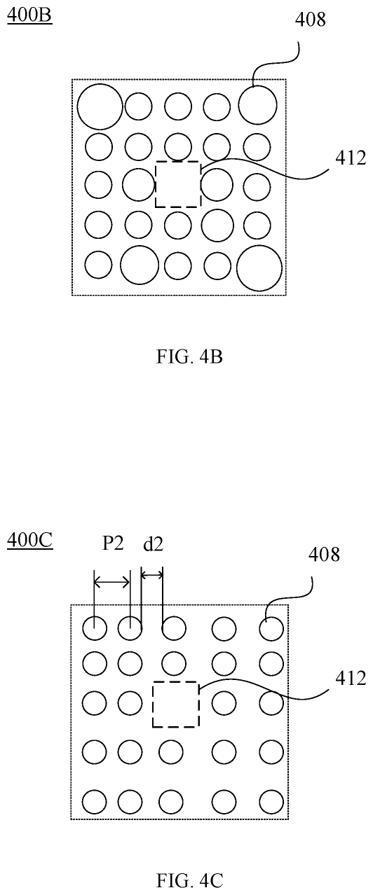

FIG. 3 shows a metasurface optical device 300 consistent with the present disclosure. As shown in FIG. 3, the metasurface optical device 300 includes a substrate 302 and a nano-structure layer 304 (the part inside the large dashed line frame) arranged on the substrate 302. The nano-structure layer 304 includes a plurality of photonic crystal units 310. In some embodiments of the present disclosure, the photonic crystal units 310 can be identical. In other embodiments of the present disclosure, the photonic crystal units 310 may be not completely the same. The plurality of photonic crystal units 310 can be arranged on the substrate 302 in an array. In some embodiments of the present disclosure, the photonic crystal units 310 can be arranged with a constant period. In some other embodiments of the present disclosure, the photonic crystal units 310 can be arranged in a non-constant period. Each photonic crystal unit 310 includes a plurality of nano-structure units 308 arranged on the substrate 302. Each photonic crystal unit 310 can be surrounded by the protection medium material covering the substrate 302. The protection medium material can provide protection and support for the plurality of photonic crystal units 310. A material type of the protection medium material is not limited, for example, can include at least one of single crystalline silicon, polycrystalline silicon, amorphous silicon, silicon carbide, titanium dioxide, silicon nitride, germanium, hafnium dioxide, or group III-V compound semiconductor. The group III-V compound can be a compound formed by boron, aluminum, gallium, or indium of group III with nitrogen, phosphorus, arsenic, or antimony of group V in the element periodic table, such as gallium phosphide, gallium nitride, gallium arsenide, indium phosphide, etc.

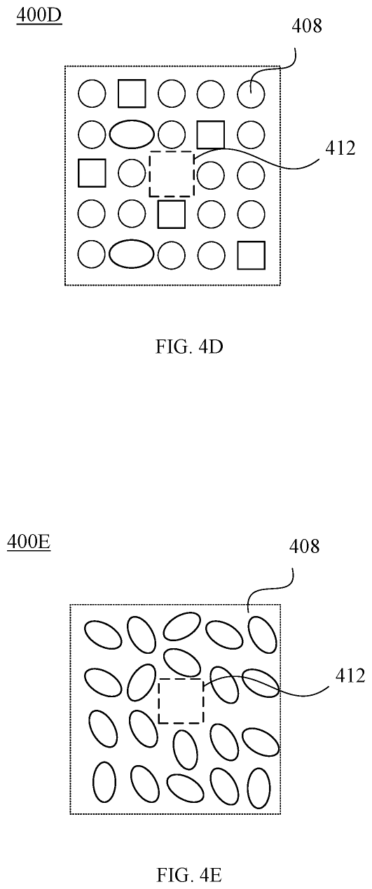

FIG. 4A schematically shows a structure of a photonic crystal unit 400A consistent with the disclosure. The photonic crystal unit 400A includes a plurality of nano-structure units 408, which can have a structural size smaller than a working wavelength, can be generally in the order of nanometer, or can be in the order of micrometer. Shapes of orthogonal projections of the plurality of nano-structure units 408 on the substrate 402 can be circle. The circular orthogonal projections can have a same radius. An interval d2 exists between adjacent nano-structure units 408. The interval d2 can be broadly understood as a minimum distance between the adjacent nano-structure units 408. An arrangement period P2 of the nano-structure units 408 can be broadly understood as a distance between the geometric centers of adjacent nano-structure units 408. The plurality of nano-structure units 408 can be arranged according to a certain rule to form the energy bandgap on the cross-section of the photonic crystal unit 400A. It is difficult for the light to pass through the energy bandgap during propagation. Therefore, even if the refractive index of the material of the center area 412 on the cross-section of the photonic crystal unit 400A is smaller than the refractive index of the protection medium material, the light can mainly propagate in the center area 412 surrounded by the energy bandgap. An arrangement pattern of the plurality of nano-structure units 408 in the photonic crystal unit 400A is not limited, e.g., can be one of a rectangular pattern, a triangular pattern, a rhombus pattern, a hexagonal pattern, and a random arrangement pattern.

In some embodiments of the present disclosure, in each photonic crystal unit, the plurality of nano-structure units can be arranged at a constant period. As shown in FIG. 4A, in the photonic crystal unit 400A, the arrangement period P2 of the plurality of nano-structure units 408 remains unchanged. When the plurality of nano-structure units in different photonic crystal units have different constant period values, the photonic crystal units can have different effective refractive indices.

In other embodiments of the present disclosure, in each photonic crystal unit, the plurality of nano-structure units can be arranged in a non-constant period. As shown in FIG. 4C, in a photonic crystal unit 400C, the arrangement period P2 of the plurality of nano-structure units 408 has a variable value. The plurality of nano-structure units of the photonic crystal unit can be arranged in a non-constant period, which can change the structure of the photonic crystal unit to change the effective refractive index of the photonic crystal unit (compared to the plurality of nano-structure units being arranged in the constant period).

In some other embodiments of the present disclosure, in each photonic crystal unit, the plurality of nano-structure units can be configured to satisfy at least one of the following conditions: the shapes of the orthogonal projections of the plurality of nano-structure units on the substrate being not completely the same, the sizes of the orthogonal projections of the plurality of nano-structure units on the substrate being not completely the same, the sizes of the plurality of nano-structure units in the direction perpendicular to the substrate being not completely the same, intervals between adjacent nano-structure units of the plurality of nano-structure units being not completely the same, orientations of the orthogonal projections of the plurality of nano-structure units on the substrate being not completely the same, angles of center axes of the plurality of nano-structure units relative to the substrate being not completely the same, and materials of the nano-structure units being not completely the same.

In some embodiments, the shapes of the orthogonal projections of the plurality of nano-structure units on the substrate are not completely the same. For example, as shown in FIG. 4D, in a photonic crystal unit 400D, shapes of the plurality of nano-structure units 408 on the substrate can be circle, ellipse, rectangle, hexagon, triangle, fan-shape, etc., or an asymmetrical shape.

In some embodiments, the sizes of the orthogonal projections of the plurality of nano-structure units on the substrate are not completely the same. For example, as shown in FIG. 4B in a photonic crystal unit 400B, circular orthogonal projections of the plurality of nano-structure units 408 on the substrate have different radii. In some other examples, elliptical orthogonal projections of the plurality of nano-structure units 408 on the substrate can have different semi-major axes and semi-minor axes; or rectangular orthogonal projections or hexagonal orthogonal projections can have different side lengths, etc.

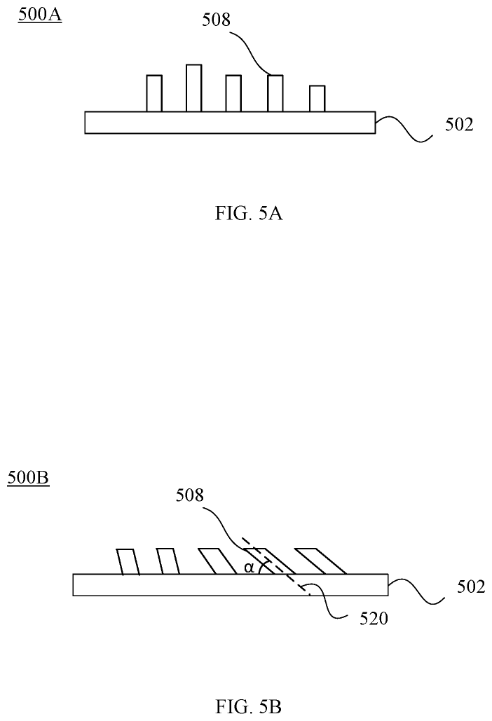

In some embodiments, the sizes of the plurality of nano-structure units in the direction perpendicular to the substrate are not completely the same. For example, as shown in FIG. 5A, in a photonic crystal unit 500A, a plurality of nano-structure units 508 have different heights in a direction perpendicular to a substrate 502.

In some embodiments, the intervals between adjacent nano-structure units of the plurality of nano-structure units are not completely the same. For example, as shown in FIG. 4C, in a photonic crystal unit 400C, the interval d2 between the plurality of nano-structure units 408 is a variable value.

In some embodiments, the orientations of the orthogonal projections of the plurality of nano-structure units on the substrate are not completely the same. For example, as shown in FIG. 4E, in a photonic crystal unit 400E, orthogonal projections of the plurality of nano-structure units 408 on the substrate have different angles relative to a reference direction.

In some embodiments, angles of center axes of the plurality of nano-structure units relative to the substrate are not completely the same. For example, as shown in FIG. 5B, in a photonic crystal unit 500B, angles α of central axes 520 of the plurality of nano-structure units 508 relative to the substrate 502 have different values.

In some embodiments, the materials of the nano-structure units are not completely the same. For example, the materials of the plurality of nano-structure units can be two or more of single crystalline silicon, polycrystalline silicon, amorphous silicon, silicon carbide, titanium dioxide, silicon nitride, germanium, hafnium dioxide, and group III-V compound semiconductor.

When a plurality of nano-structure units of a photonic crystal unit are arranged according to the above rules, the energy bandgap formed in the photonic crystal unit can be changed to perform the modulation on the effective refractive index of the photonic crystal unit. Therefore, when the light passes through the photonic crystal units with different effective refractive indices, wavefronts modulated by the different effective refractive indices can be obtained.

In some other embodiments of the present disclosure, in each photonic crystal unit, the shapes of the orthogonal projections of the plurality of nano-structure units on the substrate can be identical, the sizes of the orthogonal projections of the plurality of nano-structure units on the substrate can be identical, the plurality of nano-structure units can have a same size in the direction perpendicular to the substrate, the intervals between adjacent nano-structure units of the plurality of nano-structure units can be identical, the orientations of the orthogonal projections of the plurality of nano-structure units on the substrate can be identical, the angles of the center axes of the plurality of nano-structure units relative to the substrate can be identical, and the materials of the plurality of nano-structure units can be identical. When a plurality of nano-structure units of a photonic crystal unit are arranged according to the above rule, the manufacturing process complexity of the photonic crystal unit can be reduced to reduce the manufacturing cost.

In some embodiments of the present disclosure, when there is no conflict, the plurality of photonic crystal units in the nano-structure layer can be a combination of the above various configurations. In some embodiments, the plurality of photonic crystal units can be of the same type of photonic crystal units. Thus, the manufacturing process complexity of the metasurface optical device can be reduced, and the manufacturing cost can be reduced. Moreover, if the period of the photonic crystal units varies, after the light passes through the metasurface optical device, a modulated outgoing light wavefront different from the incident light wavefront can be obtained.

In some other embodiments, the plurality of photonic crystal units can include different types of photonic crystal units, for example, the plurality of photonic crystal units include at least one first photonic crystal unit and at least one second photonic crystal unit. The second photonic crystal unit can be different from the first photonic crystal unit in at least one of the following aspects: the shape of the orthogonal projection of the nano-structure unit on the substrate, the size of the orthogonal projection of the nano-structure unit on the substrate, the size of the nano-structure unit in the direction perpendicular to the substrate, the interval between the adjacent nano-structure units, the arrangement period of the nano-structure units, the orientation of the orthogonal projection of the nano-structure unit on the substrate, the angle of the center axis of the nano-structure unit relative to the substrate, the arrangement pattern of the nano-structure units on the substrate, and the material of the nano-structure unit. When the sizes of the nano-structure units of the second photonic crystal unit and the first photonic crystal unit are different in the direction perpendicular to the substrate (that is, the height of the second photonic crystal unit is different from the height of the first photonic crystal unit), the optical path of light in the second photonic crystal unit is different from the optical path of light in the first photonic crystal unit. Thus, the outgoing light can have different phases. When the second photonic crystal unit and the first photonic crystal unit have different parameters other than the height, the second photonic crystal unit and the first photonic crystal unit can have different effective refractive indices. Thus, when the light passes through the metasurface optical device, the light can be modulated by the plurality of photonic crystal units with different refractive indices to the wavefront modulated by different effective refractive indices.

In some embodiments of the present disclosure, the first photonic crystal unit can include, for example, one of the photonic crystal units 400A to 500B shown in FIGS. 4A to 5B, and the second photonic crystal unit can include, for example, another one of the photonic crystal units 400A to 500B shown in FIGS. 4A to 5B.

With further reference to FIG. 3, the arrangement of the plurality of photonic crystal units 310 of the nano-structure layer 304 is described. The arrangement period P1 of the plurality of photonic crystal units 310 on the substrate 302 can be broadly understood as the distance between geometric centers of adjacent photonic crystal units 310. The interval d1 between the adjacent photonic crystal units 310 can be broadly understood as a minimum distance between adjacent photonic crystal units 310.

In some embodiments of the present disclosure, the plurality of photonic crystal units of the nano-structure layer can be arranged at a constant period on the substrate. As shown in FIG. 3, the arrangement period P1 of the plurality of photonic crystal units 310 is constant. Thus, if the plurality of photonic crystal units 310 include different types of photonic crystal units, after the light passes through the plurality of photonic crystal units 310, wavefronts modulated by different effective refractive indices can be obtained.

In some other embodiments of the present disclosure, the plurality of photonic crystal units of the nano-structure layer can be arranged on the substrate at a non-constant period. For example, the arrangement period P1 of the plurality of photonic crystal units 310 in FIG. 3 varies. Thus, after the light passes through the plurality of photonic crystal units 310, the outgoing light wavefront different from the incident light wavefront can be obtained.

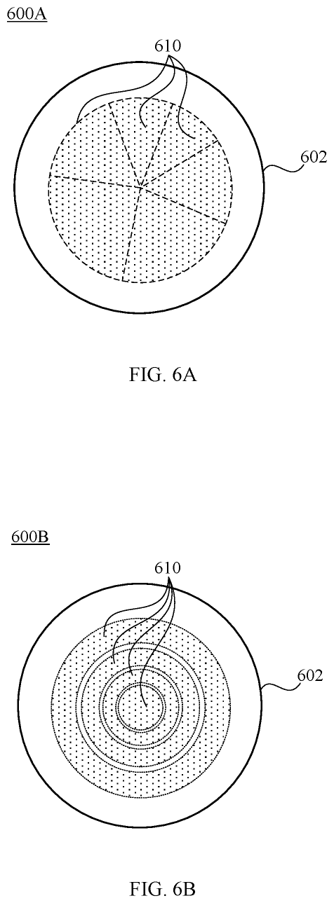

The arrangement of the plurality of photonic crystal units on the substrate is not limited. The arrangement of the plurality of photonic crystal units on the substrate can be designed accordingly based on the specific application of the metasurface optical device. In some embodiments of the present disclosure, the plurality of photonic crystal units can be arranged in an array on the substrate, including but not limited to an array arrangement in a polar coordinate system, a rectangular array arrangement, a triangular array arrangement, and a hexagonal array arrangement, etc. In some other embodiments of the present disclosure, the plurality of photonic crystal units can be sequentially arranged on the substrate along a circumferential direction of a circle. When the plurality of photonic crystal units include different types of photonic crystal units, areas formed by different types of photonic crystal units can be nested and arranged sequentially on the substrate along a circumferential direction of the circle. As shown in FIG. 6A, in a metasurface optical device 600A, a plurality of areas 610 formed by different types of photonic crystal units on a substrate 602 are nested and arranged sequentially along the circumferential direction of the circle. The plurality of area 610 can have different central angles along the circumferential direction of the circle. In some other embodiments of the present disclosure, the plurality of photonic crystal units can be sequentially arranged on the substrate along a radial direction of the circle. When the plurality of photonic crystal units include different types of photonic crystal units, the areas formed by different types of photonic crystal units can be nested and arranged sequentially on the substrate along the radial direction of the circle. As shown in FIG. 6B, in the metasurface optical device 600B, the plurality of areas 610 formed by different types of photonic crystal units on the substrate 602 are nested and arranged sequentially along the radial direction of the circle. The plurality of areas 610 can have different widths in the radial direction of the circle.

In some embodiments of the present disclosure, the plurality of nano-structure units of the photonic crystal unit can be nanopillars, that is, column-shaped structures protruding from the substrate. In some other embodiments, the plurality of nano-structure units of the photonic crystal unit can also be nanoholes, that is, a plurality of hole structures formed in the nano-structure layer. The plurality of hole structures can be filled with, for example, air.

In some embodiments of the present disclosure, a surface of the substrate facing away from the nano-structure layer and/or a surface of the substrate facing the nano-structure layer can be coated with a reflection layer. In some embodiments, the reflection layer can completely cover a side of the substrate where the nanoholes are arranged and can be arranged between the nano-structure layer including the nanoholes and the substrate. In some other embodiments, the reflection layer can completely cover another side of the substrate, that is, completely cover a side of the substrate where no nanoholes are arranged.

A type of the reflection layer is not limited. In some embodiments, the reflection layer can be one of a metal reflection layer, a dielectric reflection layer, and a metal-dielectric reflection layer, with a relatively high reflectivity. By adding the reflection layers with relatively high reflectivity, the metasurface optical device of the present disclosure can be used as a reflection member to reflect the locally modulated light through the plurality of nanoholes back instead of allowing the locally modulated light to pass through the metasurface optical device.

In some other embodiments, the reflection layer can include a grating or a dielectric material layer. Thus, after the light enters the metasurface optical device of the present disclosure, the light is neither completely transmitted nor fully reflected. A part of the light can be transmitted through the metasurface optical device, and a part of the light can be reflected. A ratio of transmitted light to reflected light can be adjusted according to actual needs. In some embodiments, 80% of the light can be transmitted, and 20% of the light can be reflected. In some other embodiments, 20% of the light can be transmitted, and 80% of the light can be reflected. In some other embodiments, 50% of the light can be transmitted, and 50% of the light can be reflected. When the reflection layer is a grating (the grating is surrounded by a dielectric material to have a flat surface, and the reflection layer can include a multi-layer grating), the ratio of the transmitted light to the reflected light can be adjusted by changing the refractive index of the grating, the refractive index of the material between adjacent layers of the grating, and the thickness of each layer of the grating, etc. When the reflection layer is a dielectric material layer, the ratio of the transmitted light to the reflected light can be adjusted by changing a difference between the refractive index of the dielectric material layer and the refractive index of the material of the substrate.

In embodiments of the present disclosure, a type of the material of the substrate is not limited. For example, the material of the substrate can include any one of glass, quartz, polymer, and plastic. The type of the material of the nano-structure layer is not limited. For example, the material of the nano-structure layer can include at least one of single crystalline silicon, polycrystalline silicon, amorphous silicon, silicon carbide, titanium dioxide, silicon nitride, germanium, hafnium dioxide, or group III-V compound semiconductor. The group III-V compound can be a compound formed by boron, aluminum, gallium, indium of group III with nitrogen, phosphorus, arsenic, antimony of group V in the element periodic table, such as gallium phosphide, gallium nitride, gallium arsenide, indium phosphide, etc.

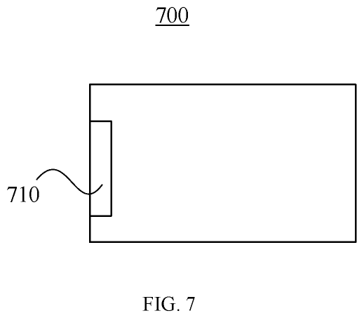

Embodiments of the present disclosure also provide an optical apparatus. As shown in FIG. 7, an optical apparatus 700 includes a metasurface optical device 710. The metasurface optical device 710 can include a metasurface optical device consistent with the disclosure, such as any of the example metasurface optical devices described above. A specific product type of the optical apparatus 700 is not limited. For example, the optical apparatus 700 can be a lens of an augmented reality wearable apparatus, a virtual reality wearable apparatus, a mobile terminal, etc., a spectrometer, a microscope, a telescope, etc. Since the optical performance of the metasurface optical device 710 is improved, the optical apparatus 700 can also have better optical performance.

Several different embodiments or examples are described in the present disclosure. These embodiments or examples are exemplary and are not intended to limit the scope of the present disclosure. Those skilled in the art can conceive of various modifications or substitutions based on the disclosed contents, and such modifications and substitutions should be included in the scope of the present disclosure. A true scope and spirit of the invention is indicated by the following claims.

What is claimed is:

1. A metasurface optical device comprising:
a substrate; and
a nano-structure layer arranged on the substrate and including a plurality of photonic crystal units, each photonic crystal unit of the plurality of photonic crystal units including a plurality of nano-structure units arranged on the substrate such that an energy bandgap is formed in a cross-section of the photonic crystal unit parallel to the substrate, and the energy bandgap surrounding a center area of the cross-section.

2. The device of claim 1, wherein the plurality of nano-structure units in each photonic crystal unit satisfy at least one of:
shapes of orthogonal projections of the nano-structure units on the substrate being not completely same;
sizes of the orthogonal projections of the nano-structure units on the substrate being not completely same;
sizes of the nano-structure units in a direction perpendicular to the substrate being not completely same;
intervals between adjacent ones of the nano-structure units being not completely same;
orientations of the orthogonal projections of the nano-structure units on the substrate being not completely same;
angles of center axes of the nano-structure units relative to the substrate being not completely same; or
materials of the nano-structure units being not completely same.

3. The device of claim 1, wherein the plurality of photonic crystal units include a first photonic crystal unit and a second photonic crystal unit, the nano-structure units in the first photonic crystal unit being different from the nano-structure units in the second photonic crystal unit.

4. The device of claim 3, wherein the first photonic crystal unit and the second photonic crystal unit satisfy at least one of:
shapes of orthogonal projections of the nano-structure units in the first photonic crystal unit on the substrate being different from shapes of orthogonal projections of the nano-structure units in the second photonic crystal unit on the substrate;
sizes of the orthogonal projections of the nano-structure units in the first photonic crystal unit on the substrate being different from sizes of the orthogonal projections of the nano-structure units in the second photonic crystal unit on the substrate;
sizes of the nano-structure units in the first photonic crystal unit in a direction perpendicular to the substrate being different from sizes of the nano-structure units in the second photonic crystal unit in a direction perpendicular to the substrate;
an interval between adjacent ones of the nano-structure units in the first photonic crystal unit being different from an interval between adjacent ones of the nano-structure units in the second photonic crystal unit;
an arrangement period of the nano-structure units in the first photonic crystal unit being different from an arrangement period of the nano-structure units in the second photonic crystal unit;
orientations of the orthogonal projections of the nano-structure units in the first photonic crystal unit on the substrate being different from orientations of the orthogonal projections of the nano-structure units in the second photonic crystal unit on the substrate;
angles of center axes of the nano-structure units in the first photonic crystal unit relative to the substrate being different from angles of center axes of the nano-structure units in the second photonic crystal unit relative to the substrate;
an arrangement pattern of the nano-structure units in the first photonic crystal unit on the substrate being different from an arrangement pattern of the nano-structure units in the second photonic crystal unit on the substrate; or
a material of the nano-structure units in the first photonic crystal unit being different from a material of the nano-structure units in the second photonic crystal unit.

5. The device of claim 3, wherein the plurality of nano-structure units in the first photonic crystal unit are arranged at a non-constant period.

6. The device of claim 3, wherein the plurality of nano-structure units in the second photonic crystal unit are arranged at a non-constant period.

7. The device of claim 1, wherein the plurality of photonic crystal units are arranged at a non-constant period on the substrate.

8. The device of claim 7, wherein the plurality of nano-structure units in each photonic crystal unit satisfy at least one of:
shapes of orthogonal projections of the nano-structure units on the substrate being not completely same;
sizes of the orthogonal projections of the nano-structure units on the substrate being not completely same;
sizes of the nano-structure units in a direction perpendicular to the substrate being not completely same;
intervals between adjacent ones of the nano-structure units being not completely same;
orientations of the orthogonal projections of the nano-structure units on the substrate being not completely same;
angles of center axes of the nano-structure units relative to the substrate being not completely same; or
materials of the nano-structure units being not completely same.

9. The device of claim 1, wherein the plurality of photonic crystal units are arranged in an array on the substrate.

10. The device of claim 1, wherein the plurality of photonic crystal units are arranged sequentially along a circumferential direction of a circle on the substrate.

11. The device of claim 1, wherein the plurality of photonic crystal units are arranged sequentially along a radial direction of a circle on the substrate.

12. The device of claim 1, wherein the plurality of nano-structure units include nanopillars.

13. The device of claim 1, wherein the plurality of nano-structure units include nanoholes.

14. The device of claim 1, further comprising:
a reflection layer formed on a surface of the substrate away from the nano-structure layer.

15. The device of claim 1, further comprising:
a reflection layer formed on a surface of the substrate facing the nano-structure layer.

16. An optical apparatus comprising a metasurface optical device including:
a substrate; and
a nano-structure layer arranged on the substrate and including a plurality of photonic crystal units, each photonic crystal unit of the plurality of photonic crystal units including:
a plurality of nano-structure units arranged on the substrate such that an energy bandgap is formed in a cross-section of the photonic crystal unit parallel to the substrate, and the energy bandgap surrounding a center area of the cross-section.

17. The apparatus of claim 16, wherein the plurality of nano-structure units in each photonic crystal unit satisfy at least one of:
shapes of orthogonal projections of the nano-structure units on the substrate being not completely same;
sizes of the orthogonal projections of the nano-structure units on the substrate being not completely same;
sizes of the nano-structure units in a direction perpendicular to the substrate being not completely same;
intervals between adjacent ones of the nano-structure units being not completely same;
orientations of the orthogonal projections of the nano-structure units on the substrate being not completely same;
angles of center axes of the nano-structure units relative to the substrate being not completely same; or
materials of the nano-structure units being not completely same.

18. The apparatus of claim 16, wherein the plurality of photonic crystal units include a first photonic crystal unit and a second photonic crystal unit, the nano-structure units in the first photonic crystal unit being different from the nano-structure units in the second photonic crystal unit.

19. The apparatus of claim 18, wherein the first photonic crystal unit and the second photonic crystal unit satisfy at least one of:
shapes of orthogonal projections of the nano-structure units in the first photonic crystal unit on the substrate being different from shapes of orthogonal projections of the nano-structure units in the second photonic crystal unit on the substrate;
sizes of the orthogonal projections of the nano-structure units in the first photonic crystal unit on the substrate being different from sizes of the orthogonal projections of the nano-structure units in the second photonic crystal unit on the substrate;
sizes of the nano-structure units in the first photonic crystal unit in a direction perpendicular to the substrate being different from sizes of the nano-structure units in the second photonic crystal unit in a direction perpendicular to the substrate;
an interval between adjacent ones of the nano-structure units in the first photonic crystal unit being different from an interval between adjacent ones of the nano-structure units in the second photonic crystal unit;
an arrangement period of the nano-structure units in the first photonic crystal unit being different from an arrangement period of the nano-structure units in the second photonic crystal unit;
orientations of the orthogonal projections of the nano-structure units in the first photonic crystal unit on the substrate being different from orientations of the orthogonal projections of the nano-structure units in the second photonic crystal unit on the substrate;
angles of center axes of the nano-structure units in the first photonic crystal unit relative to the substrate being different from angles of center axes of the nano-structure units in the second photonic crystal unit relative to the substrate;
an arrangement pattern of the nano-structure units in the first photonic crystal unit on the substrate being different from an arrangement pattern of the nano-structure units in the second photonic crystal unit on the substrate; or
a material of the nano-structure units in the first photonic crystal unit being different from a material of the nano-structure units in the second photonic crystal unit.

20. The apparatus of claim 18, wherein the plurality of nano-structure units in the first photonic crystal unit are arranged at a non-constant period.
